(19) United States
(12) Patent Application Publication
(10) Pub. No.: US 2023/0391003 A1
(43) Pub. Date: Dec. 7, 2023

(54) Contour Smoothing for Material Extrusion Three-Dimensionally Printed Parts

(71) Applicant: Essentium IPCO, LLC, Pflugerville, TX (US)

(72) Inventor: Charles Brandon Sweeney, Pflugerville, TX (US)

(21) Appl. No.: 18/361,121

(22) Filed: Jul. 28, 2023

Related U.S. Application Data
(63) Continuation of application No. PCT/US2022/013277, filed on Jan. 21, 2022.
(60) Provisional application No. 63/143,306, filed on Jan. 29, 2021.

(51) Int. Cl. B29C 64/188; B29C 64/118; B29C 64/393; B29C 64/209; B33Y 10/00; B33Y 40/20; B33Y 30/00; B33Y 50/02

(52) U.S. Cl. CPC B29C 64/188; B29C 64/118; B29C 64/393; B33Y 50/02; B33Y 10/00; B33Y 40/20; B33Y 30/00; B29C 64/209

(57) ABSTRACT

A system, method, and three-dimensional printer for contouring a three-dimensional printed part. The system including the three-dimensional printer and processor control system for performing a method of contouring the three-dimensional part. The method including printing a three-dimensionally printed part by depositing a filament in a primary print path with a three-dimensional print head, wherein the three-dimensionally printed part includes a surface oriented in a build direction; and smoothing the surface oriented in the build direction by moving a reflow tool along a smoothing path while printing the three-dimensionally printed part.

### CROSS-REFERENCE TO RELATED APPLICATIONS

The present application claims the benefit of U.S. Provisional Application 63/142,306, filed on Jan. 29, 2021, the teachings of which are incorporated herein.

### FIELD

The present disclosure relates to a three-dimensional (3D) printer, system, and method for smoothing, sealing, and bonding filament layers of a three-dimensionally printed part using a reflow tool in a three-dimensional printer to thermally reflow the outer surfaces of the part while it is being printed.

### BACKGROUND

In three-dimensional (3D) printing, a form of additive manufacturing, parts are formed by the deposition of sequential layers of material, often provided in the form of a filament. To print a three-dimensionally printed part, a three-dimensional representation of the part may be created in or imported into computer aided drafting software. This representation is sliced into layers, which may be planar or non-planar, and computer numerical code is generated to sequentially print the layers in a build direction, on a print platform in a three-dimensional printer. The layers may be printed by extruding filament, which is softened, and sometimes even melted, in an extruder and solidifies upon deposition.

In typical material extrusion three-dimensional printing, three-dimensionally printed parts suffer from relatively poor surface finish and porosity caused, in part, by the sequential deposition of the layers of filament. The filament layers often form crevices and openings between the layers in the build direction. An additional source of surface defects is stair-stepping. Stair-stepping is caused by transitions in the print profile due to, e.g., dimensional changes between sequential layers. Stair stepping may be visually undesirable in some completed parts and may also cause a degree of porosity. Additional sources of poor surface finish and porosity include, but are not limited to, curling or rough corners, portions of the parts that touch support structures, stringing of the material when the print head travels and moves between sections of a part layer, and blobs on the print surface.

Existing techniques for improving the surface finish or porosity of three-dimensionally printed parts formed by material extrusion are typically performed in offline, post processing methods that involve surface coatings, mechanical polishing, vapor polishing, laser treatment, and other costly or time-consuming methods. In addition, some three-dimensional printing workflows exist for smoothing top layers of printed parts using a software workflow. In one process, referred to as ironing, a hot nozzle travels over a printed top layer to deposit a second infill phase and flatten any deposited filament that might have curled up. Due in part to hardware limitations, the surfaces in the build direction of a three-dimensionally printed part may benefit little from ironing. In addition, top surfaces of three-dimensionally printed parts typically have better surface finish compared to the sides of the three-dimensionally printed parts where the sequential build layers are relatively more visible. Thus, the top surfaces of the printed parts benefit little, if at all, from a final smoothing pass.

Thus, while methods of smoothing surfaces achieve their intended purpose, there is need for a new and improved three-dimensional printer, system, and method for finishing three-dimensionally printed part surfaces and, particularly, surfaces oriented in the build direction.

### SUMMARY

According to several aspects, the present disclosure relates to a system for contouring a three-dimensional printed part. The system includes a three-dimensional printer and a processor control system The three-dimensional printer includes a three-dimensional print head carried by an x,y gantry in the three-dimensional printer, the three-dimensional print head including a heated extrusion nozzle The processor control system includes executable code to print a three-dimensionally printed part by depositing a filament trace in a printing path with the three-dimensional print head, wherein the three-dimensionally printed part includes a surface oriented in a build direction, and smooth the surface oriented in the build direction by moving a reflow tool along a smoothing path while printing the three-dimensionally printed part.

In aspects of the above, the process control system further includes executable code to generate the primary print path from a representation of the three-dimensionally printed part, wherein the primary print path includes a plurality of primary print layers; and generate a smoothing path, wherein the smoothing path includes a plurality of smoothing layers. In further aspects, the representation of the three-dimensionally printed part is scaled to create the smoothing path.

In additional aspects of the above aspects, the processor control system includes executable code to interweave the plurality of primary print layers and the plurality of smoothing layers. In further aspects, the processor control system includes executable code to begin the smoothing path after at least two of the plurality of primary print layers have been printed.

In additional aspects of the above, the processor control system includes executable code to generate the primary printing path by creating commands for use by the three-dimensional printer through dividing the representation of the three-dimensionally printed part into the plurality of primary print layers and creating a plurality of instructions for depositing an extruded filament in each layer of the plurality of primary print layers.

In additional aspects of the above aspects, the processor control system includes executable code to generate the smoothing path by dividing the representation of the three-dimensionally printed part into the plurality of smoothing layers and creating the smoothing path at an offset from the printing path and creating a plurality of instructions for moving a reflow tool through the plurality of smoothing layers.

In additional aspects of the above aspects, the heated extrusion nozzle includes a heated extrusion nozzle tip and the reflow tool is the heated extrusion nozzle tip.

In additional aspects of the above aspects, instructions to smooth the surface include creating a texture or design in the surface.

In additional aspects of the above aspects, the reflow tool includes a contacting surface geometry and the reflow tool imparts a smoothing profile on the three-dimensionally printed part in a range of 0 to plus or minus 10 degrees inverse of the reflow tool contacting surface geometry.

According to several aspects, the present disclosure relates to a method for contouring a three-dimensional printed part, comprising printing a three-dimensionally printed part by depositing a filament in a primary print path with a three-dimensional print head, wherein the three-dimensionally printed part includes a surface oriented in a build direction; and smoothing the surface oriented in the build direction by moving a reflow tool along a smoothing path while printing the three-dimensionally printed part.

In additional aspects, the method includes generating the primary print path from a representation of a three-dimensionally printed part, wherein the primary print path includes a plurality of primary print layers; and generating a smoothing path, wherein the smoothing path includes a plurality of smoothing layers. In further aspects, the method includes interweaving the plurality of primary print layers with the plurality of smoothing layers. In yet further aspects, the method includes beginning the smoothing path after at least two of the plurality of primary print layers. In additional further aspects, the method includes generating the primary print path by dividing the representation of the three-dimensionally printed part into the plurality of primary print layers and creating a plurality of instructions for depositing filament in each of the plurality of primary print layers. In additional further aspects, the method includes generating the smoothing path by dividing the representation of the three-dimensionally printed part into the plurality of smoothing layers and creating the smoothing path at an offset from the printing path and creating a plurality of instructions for moving a reflow tool through the plurality of smoothing layers. In yet further aspects, the method further comprises setting an extrusion multiplier to zero in the smoothing path when a headed nozzle tip is used as the reflow tool. In further aspects, the method includes the smoothing path creates interference between the reflow tool and the three-dimensionally printed part.

In further aspects of any of the above aspects, the method includes smoothing includes imparting a texture or design in the surface.

According to several aspects, the present disclosure relates to a three-dimensional printer. The three-dimensional printer includes a processor control system. The processor control system includes executable code to print a three-dimensionally printed part by depositing a filament trace in a printing path with the three-dimensional print head, wherein the three-dimensionally printed part includes a surface oriented in a build direction; and smooth the surface oriented in the build direction by moving a reflow tool along a smoothing path while printing the three-dimensionally printed part.

### BRIEF DESCRIPTION OF THE DRAWINGS

The drawings described herein are for illustration purposes only and are not intended to limit the scope of the present disclosure in any way.

FIG. 1 illustrates a schematic of a three-dimensional printer and a system for three-dimensional printing a three-dimensionally printed part by material extrusion according to an aspect of the present disclosure;

FIG. 2 illustrates an embodiment of a method of printing a three-dimensionally printed part and smoothing a surface of the three-dimensionally printed part oriented in the build direction of the part according to an aspect of the present disclosure;

FIG. 3 is an embodiment of a three-dimensional representation of a computer aided design of a pyramid primary printing path wherein a portion of the primary printing path and a smoothing path, according to an aspect of the present disclosure;

FIG. 4 is a close-up view of a corner of the pyramid of FIG. 3, illustrating an embodiment of a primary printing path and a smoothing path, according to an aspect of the present disclosure;

FIG. 5 illustrates an embodiment of a cross-section of a printed filament

trace before and after smoothing;

FIG. 6 illustrates an embodiment of a schematic for smoothing a surface of a three-dimensionally printed part, wherein the surface is orientated in the build direction and includes a number of ridges formed by the filament layers, according to an aspect of the present disclosure;

FIG. 7 illustrates an embodiment of a heated extrusion nozzle, wherein the heated extrusion nozzle tip is used as a reflow tool for smoothing a surface of a three-dimensionally printed part, according to an aspect of the present disclosure;

FIG. 8A illustrates a cross-section of an embodiment of a heated extrusion nozzle tip for use as a reflow tool according to an aspect of the present disclosure;

FIG. 8B a cross-sectional, perspective view of the heated extrusion nozzle tip of FIG. 7A also for use as a reflow tool according to an aspect of the present disclosure;

FIG. 9 illustrates an embodiment of a smoothing tool also for use as a reflow tool for smoothing according to an aspect of the present disclosure;

FIG. 10 illustrates an embodiment of a smoothing tool for use as a reflow tool according to an aspect of the present disclosure;

FIG. 11 illustrates a three-dimensionally printed part produced with smoothing a surface oriented in the build direction in accordance with aspects of the present disclosure; and

FIG. 12 illustrates an embodiment of a schematic for smoothing a surface of a three-dimensionally printed part oriented in the build direction and smoothing the last printed layer of the three-dimensionally printed part according to an aspect of the present disclosure; and

FIG. 13 illustrates a schematic of a three-dimensionally printed part produced without smoothing in the build direction according to an aspect of the present disclosure.

### DESCRIPTION

The present disclosure relates to a three-dimensional (3D) printer, system, and method for smoothing, sealing, and bonding filament layers of a printed part using a reflow tool in a three-dimensional printer to thermally reflow the outer surfaces of the part while it is being printed. The three-dimensional printer, system, and method herein allows the preparation of a three-dimensional printed object through the selection of various parameters within the system software for execution by the three-dimensional printer for smoothing the print in-situ during the three-dimensional printing process.

In aspects, the system includes software that resides in the three-dimensional printer, in a separate computer, or in both a separate computer and in the three-dimensional printer, that generates code, such as G-code, for execution by the three-dimensional printer and the three-dimensional printer executes that code to print and smooth the three-dimensional printed part. The smoothing of the surface of the articles created by the layer-by-layer deposition of filament during three-dimensional printing may reduce artifacts and seal surfaces regardless of the orientation of the surface to the build direction and reduce porosity.

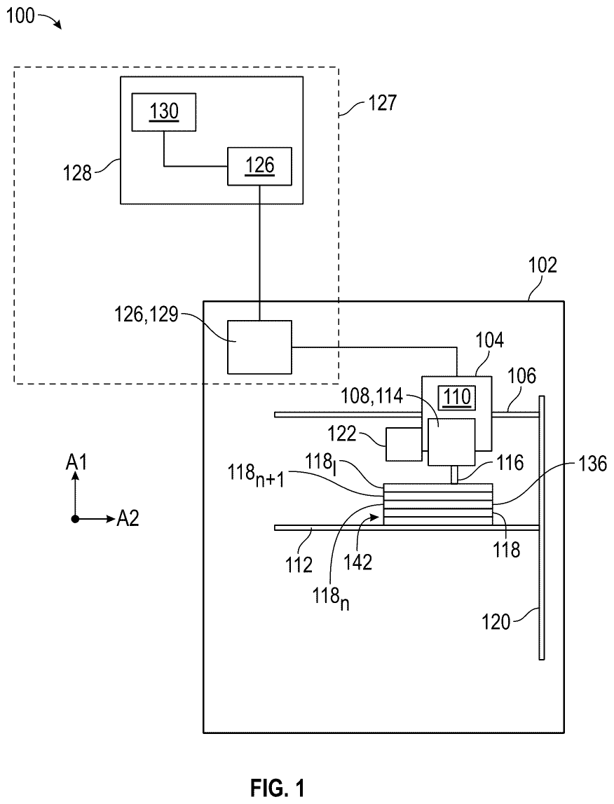

In aspects, a system for three-dimensional printing and smoothing is provided herein. FIG. 1 illustrates an aspect of a system 100 for three-dimensional printing and smoothing. The system 100 includes a three-dimensional printer 102. The three-dimensional printer 102 includes a print head 104 carried by an x-y carriage 106. The print head 104 includes a heated extrusion nozzle 108 and a feed motor 110. The system 100 further includes a print platform 112 upon which a three-dimensionally printed part 136 is built by depositing an extruded filament trace 116 on the print platform 112 in sequential layers 118. The print platform 112 is mounted on a z-axis carriage 120. The three-dimensional printer 102 includes one or more reflow tools 114. In aspects, the reflow tool 114 includes the heated extrusion nozzle 108. In alternative aspects, a reflow tool 114 is provided in addition to the heated extrusion nozzle 108 and is mounted in the print head 104. Alternatively, the reflow tools 114 are incorporated as secondary, smoothing tools 122 affixed to print head 104 as illustrated or mounted in a separately driven head on the x-y carriage 106. Reference to reflow tools 114 herein include reference to either or both of the heated extrusion nozzle 108 or a smoothing tool 122 affixed to the print head 104 or otherwise incorporated in the system, such as om a separate gantry.

Operation of the system 100 including the print head 104, the heated extrusion nozzle 108, the feed motor 110, print platform 112, and reflow tools 114, is controlled by commands received from a processor control system 127, which in exemplary aspects includes one or more processors 126. In aspects, the one or more processors include microprocessors. Where more than one processor 126 is present, the processors 126 perform distributed or parallel processing protocols and the processors 126 may include, for example, application specific integrated circuits, a programmable gate array, a field programmable gate array, a graphics processing unit, a physics processing unit, digital-signal processor, or a front-end processor.

In aspects, the processor control system 127 is located in the three-dimensional printer 102 or alternatively, or additionally, in at least one computer 128 as illustrated in FIG. 1. In aspects, the processor control system 127 includes a G-code processor 129. The G-code processor 129 receives static computer numerical control code (G-code) files and includes hardware, firmware, and software for parsing, analyzing, and optimizing the G-code and provides an executable code which may then be loaded as low-level servo controller instructions usable by the three-dimensional printer 102 for driving the print head 104, heated extrusion nozzle 108, feed motor 110, print platform 112, reflow tools 114, etc. In aspects, the G-code is created by a slicer, which manipulates a digital representation of a three-dimensionally printed part 136. In further aspects, the executable code for the slicer is also executed by one or more processors 126 in the processor control system 127. The three-dimensional representation of the three-dimensionally printed part 136 to be printed is created in, or imported into, computer aided drafting software and then imported into the slicer. This representation is sliced into layers, which are planar, non-planar, or a combination of planar and non-planar layers, and computer numerical code, the G-code, is generated to provide instructions to the three-dimensional printer 102 to sequentially print the layers 118 of a three-dimensionally printed part 136 in a build direction (defined by an axis A1, commonly referred to as the z-axis), on the print platform 112 in the three-dimensional printer 102, and smooth those layers. The G-code processor 129, in exemplary aspects, may reside in a computer independent of the three-dimensional printer 102 and the output is provided to the three-dimensional printer 102, or the G-code processor 129 may reside within the three-dimensional printer 102 itself as illustrated in FIG. 1.

The processor control system 127 also includes or accesses information stored in a memory 130, with which the processor 127 is operatively coupled, regarding the geometry of the reflow tools 114, such as the tip geometry of a heated extrusion nozzle 108 or the geometry of any additional smoothing tools 122 present in the system 100. In addition, filament information is stored in memory 130, including information about die swell or other factors that may affect printed filament trace 116 thickness. Memory 130 is understood as a physical device capable of storing information temporarily, such as in the case of random-access memory, or permanently, such as in the case of read-only memory. Representative physical devices include hard disk drives, solid state drives, optical discs, or storage accessible through the cloud over networks. The system 100 is configured to execute a process for smoothing surfaces, including surfaces 142 oriented in the build direction of a three-dimensionally printed part 136 formed by layer-by-layer deposition using a reflow tool 114.

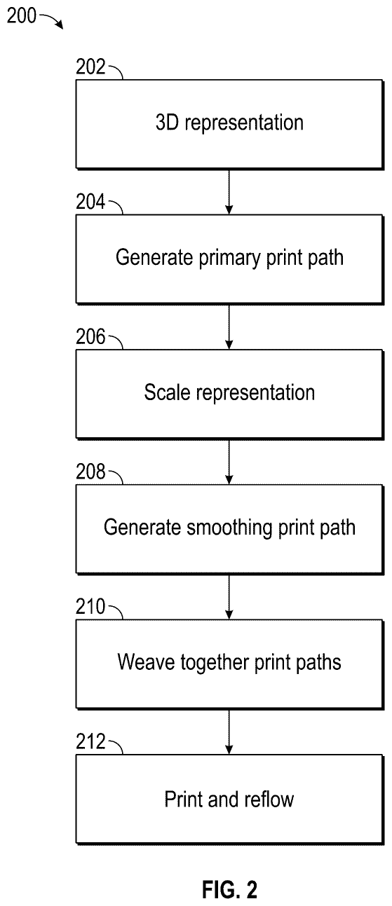

FIG. 2 illustrates an aspect of a process 200 for smoothing the exterior of a three-dimensionally printed part 136. In aspects, the process 200 begins at block 202 with the creation or importation of a three-dimensional representation of the three-dimensionally printed part 136 in computer aided drafting software. A representation of the three-dimensionally printed part 136 is understood herein as a digital model of the three-dimensionally printed part 136. The representation of the three-dimensionally printed part 136 is then manipulated in a slicer at block 204 to define the three-dimensionally printed part 136 scale relative to the representation, slice the representation of the three-dimensionally printed part 136 into a number of layers based on, e.g., an assumed filament thickness, divide each layer into segments or movements, define infill and determine exposed wall thicknesses, resulting in one or more primary print paths 134 being generated. As alluded to above, a slicer may be understood as software that receives the representation of the three-dimensionally printed part from computer aided design software and breaks the representation into layers 118, determines tool paths to print each layer 118, and calculates the amount of material to be extruded for each tool path and layer to perform the functions noted above at block 204.

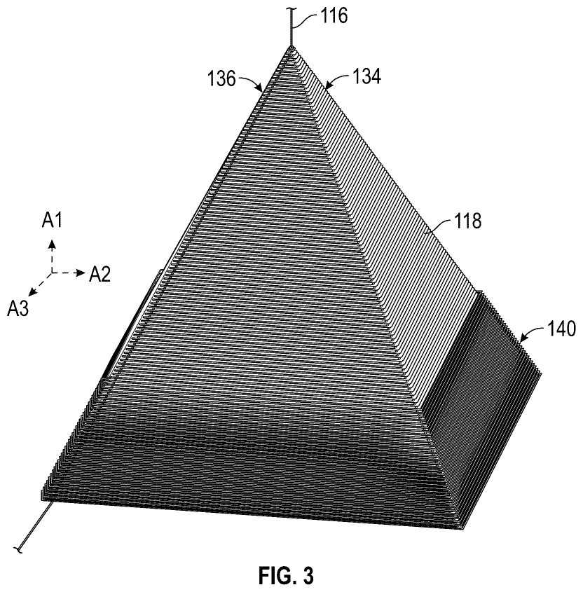

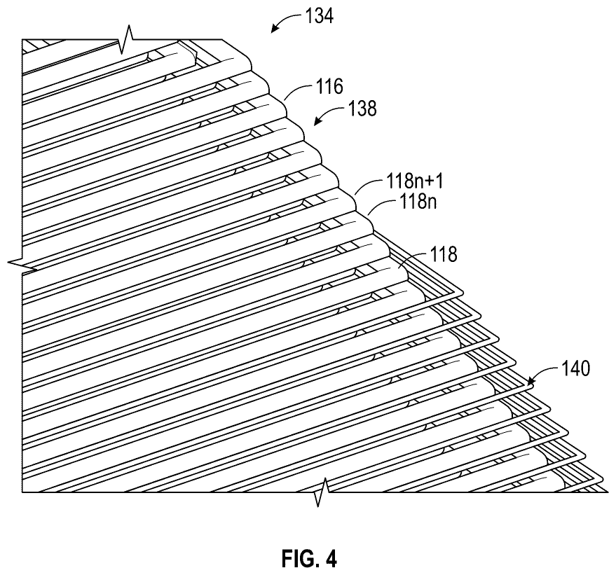

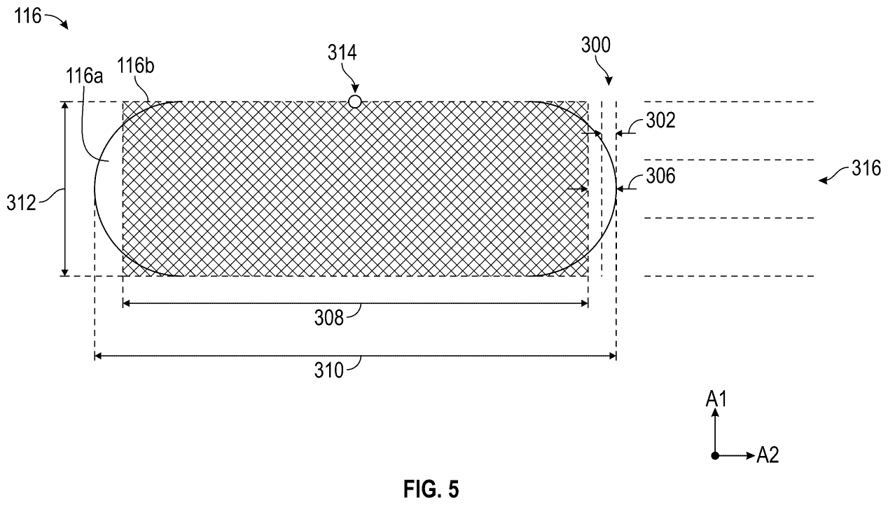

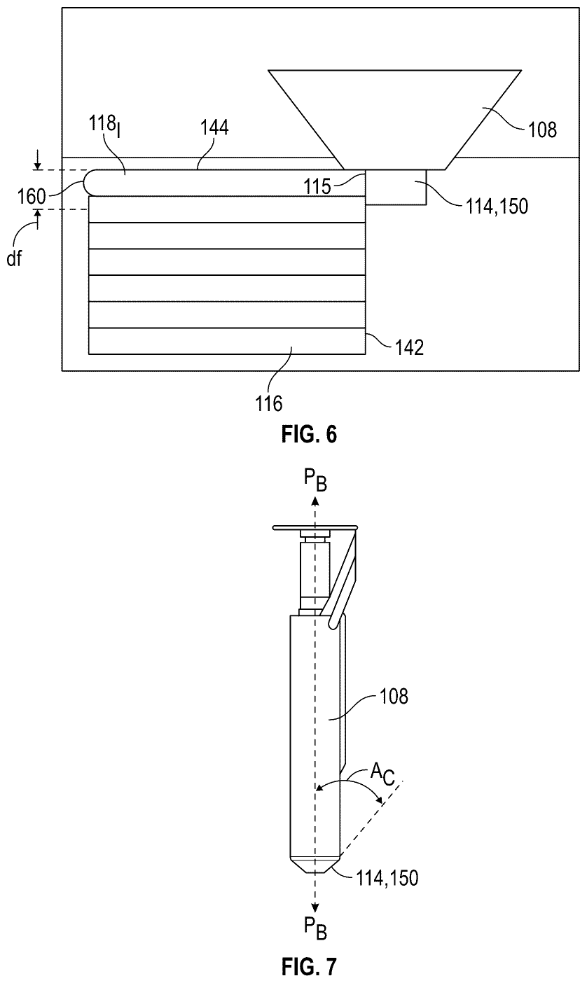

FIG. 3 and FIG. 4 illustrate an example of a representation of a primary print path 134 of a three-dimensionally printed part 136 generated after manipulating the representation of the three-dimensionally printed part 136 with a slicer. The outer wall 138 of the three-dimensionally printed part 136, which forms the surfaces 142, 144 of the three-dimensionally printed part 136 (see FIG. 6), is formed by multiple layers 118 of filament traces 116. As seen in FIG. 4 each layer 118n+1 is laid on top of the previous layer 118n. In aspects, generally flat surfaces are created by depositing layers 118n+1 directly over the previous layers 118n in the build direction, which is illustrated in the z-axis. However, as deposited, the surfaces of the three-dimensionally printed component are not completely flat due, at least in part, to the geometry of the filament trace 116 as illustrated in FIG. 5. As seen in FIG. 5, the filament trace 116 as deposited 116a assumes the shape of a rounded rectangle or oval. Laying the filament traces 116 on top of each other results in crevices formed between the layers 118. In addition, shifts in the x-y plane (defined by axis A2 and A3 and commonly referred to as the x-y axis) between subsequently deposited layers 118n+1 and previously deposited layers 118n create step-changes, which are illustrated in FIG. 3 and FIG. 4.

Referring again to FIG. 2, in aspects, the process further includes at block 206 generating a smoothing path 140. In aspects, the process 200 of generating a smoothing path 140 includes creating an offset from the printing path 134 providing the outer walls 138 of the three-dimensionally printed part 136 to create a stepover 300 in which a portion of the reflow tool 114 contacts the filament trace 116 and flattens the filament trace 116. In aspects, the size of the stepover 300 and resulting offset is determined based on the desired degree of interference 302 and between the filament trace 116a at the outer wall 138 as well as the geometry of the reflow tool 114. In additional aspects, the size of the stepover 300 may be a portion of the total desired interference 306 and the smoothing path 140 includes multiple passes to achieve the desired degree of flattening. In further aspects, the stepover 300 distance is in the range of 0.5 mm to 2.5 mm, including all values and ranges therein. And in further aspects, the stepover 300 is normal to the surface of the outer wall 138 the reflow tool 114 is contacting. As illustrated, as the deposited filament trace 116a is contacted by the reflow tool 114, the reflowed filament trace 116b becomes more rectangular 116b, this reduces the as deposited width 308 to flattened width 310 of the filament trace 116. The height 312 of the filament trace 116 may remain the same or may be altered, as described further herein.

It should be appreciated that the greater the interference between the reflow tool 114 and the outer wall 138 of the three-dimensionally printed part 136, the more material will be dislocated. In further aspects, the amount of the stepover distance may be varied through printing a single three-dimensionally printed part 136 depending on the geometry of the three-dimensional printed part 136 or desired surface texture. Reference to an outer wall 138 herein is reference to an exposed wall. For example, in the case of a three-dimensionally printed mold for molding materials, such as an injection or compression mold, the outer walls 138 include the walls that define the overall volume of the mold, the walls that define the cavities, as well as walls that define the cooling channels, ejector pin holes, vents, or etc. In the case of a cylinder including a through hole, the wall defining the through hole as well as the walls generally defined as the cylinder are the outer walls 138.

In aspects, the smoothing path 140 is generated from the slicer data pertaining to the printing path 134 or from data pertaining to the three-dimensional part itself. For example, using the printing path 134 as a reference point, the smoothing path 140 traces the printing path 134 for each layer 118 and the smoothing path 140 is created at an offset from the printing path 134 to provide the desired degree of stepover 300 as determined above. In alternative or additional aspects, the smoothing path 140 is created by increasing the dimensions of the printed part by at least one imaginary filament trace 116 and offsetting the reflow tool 114 from the centerline 314 of the imaginary filament trace 116 towards the three-dimensionally printed part 136 to create the desired degree of interference 306. The imaginary filament traces 116 are then printed without extruding filament to provide the smoothing path 140. In further alternative or additional aspects, the representation of the three-dimensionally printed part 136 is scaled up, or down, in one or more directions or axes (x, y, z), or in all directions or axes (x, y, z), by the desired amount of the stepover and the smoothing path 140 is created in a similar manner as the printing path 134 is created by the slicer. Like the printing path 134, the smoothing path 140 includes a number of smoothing layers, wherein each layer of the smoothing path generally correlates to a layer of the printing path 134. In additional, or alternative aspects, a smoothing path 140, or at least a portion thereof, is created independent of the geometry of the representation of the three-dimensionally printed part 136. In such aspects, the smoothing path 140 is created to impart a texture or design in the surface, such as characters or figures, on the outer wall 138 of the three-dimensionally printed part 136.

As alluded to above, in aspects, the flow rate of the filament 116 is reduced to zero to provide a smoothing path 140, which allows the print head 104 to trace the print path 140 without extruding filament 116. For example, in three-dimensional printers that include a constant extrusion rate programmed in the firmware, the extrusion multiplier in the G-code is dropped to zero. The extrusion multiplier may be understood as a multiplier of the flow rate set in the three-dimensional printer 102 firmware that controls the flow rate of material extruded from the heated extrusion nozzle 108 while the heated extrusion nozzle 108 traverses the print path 134, 140. An extrusion multiplier of zero (0) reduces the flow rate of the filament 116 to zero. An extrusion multiplier of one (1) results in no change in the flow rate set in the three-dimensional printer 102 firmware. An extrusion multiplier of greater than one (1) increases the flow rate to a rate that is greater than that set in the three-dimensional printer 102 firmware. In alternative or additional aspects, the smoothing path 140 is programmed as a travel path, in which the flow rate of the material is set to zero.

Referring again to FIG. 2, at block 208 the G-code for the second, smoothing path 140 is then interwoven with the G-code of the first printing path 134 for the three-dimensionally printed part 136. In aspects, the first layer of the smoothing part 140 starts after the second or third layer 118 of the printing path 134. Accordingly, given the stepover 300 between the printing path 134 and the smoothing path 140, as the three-dimensional printer 102 proceeds to trace the smoothing path 140, the reflow tool 114 (either the heated extrusion nozzle 108 or a smoothing tool 122) will stepdown 316 a given distance relative to the build direction A1 and slightly away from the three-dimensionally printed part 136 in the x-y plane defined by A2 and A3 to provide the stepover 300, as illustrated in FIG. 6.

In the aspect illustrated in FIG. 6, the tip 150 of heated extrusion nozzle 108 is provided as a reflow tool 114. For each filament layer 118, after the first or second layer, the heated extrusion nozzle 108 performs the stepdown 316 of a distance df of, e.g., 1.5 layers of printed filament 116, relative to the upper surface 144 of the last printed layer 1181 of filament 116. The stepdown 316 between the primary print path 134 and the smoothing path 140, in aspects, is determined by the geometry of the reflow tool 114 used to contour the layers 118. Accordingly, the stepdown 316 of the reflow tool 114 relative to the primary print path 134 may be anywhere from 0.25 to 3 layers of printed filament material, including all values and ranges therein, depending on the configuration of the reflow tool 114. The total interference 306 between the contact surface 115 of the reflow tool 114 and the three-dimensionally printed part 136 is, in aspects, sufficient to smooth the rounded filament traces 116 and, in aspects, seal the filament layers 118.

The shape of the reflow tool 114 will influence the smoothing profiles and minimum corner radius that can be smoothed. For instance, many desktop printers use conical heated extrusion nozzle tips 150, such as illustrated in FIG. 7. Heated extrusion nozzles 108 that have a conical tip 150, such as the aspect illustrated in FIG. 7, may be limited to smoothing surfaces 142 with the inverse angle of the nozzle tip chamfer angle. In the aspect illustrated in FIG. 7, the chamfer angle Ac is 60 degrees relative to the build plane P_{B} and smoothing profiles are effective for vertical or angled surfaces 142 with a slope of 60°+/−10 degrees, including all values and ranges from 0 to +/−10 degrees. The heated extrusion nozzle 108 of an ESSENTIUM HSE three-dimensional printer, for example, uses a jewel shaped heated extrusion nozzle tip 150 that protrudes approximately 1 mm from a metallic shank and has a vertical profile as illustrated in FIG. 6. The minimum smoothing radius coincides with the radius of the jewel leading edge, i.e., contact surface 115, and in the illustrated aspect the jewel heated extrusion nozzle tip 150 may be able to effectively smooth vertical surfaces +/−10 degrees, including all values and ranges from 0 to +/−10 degrees from the build plane.

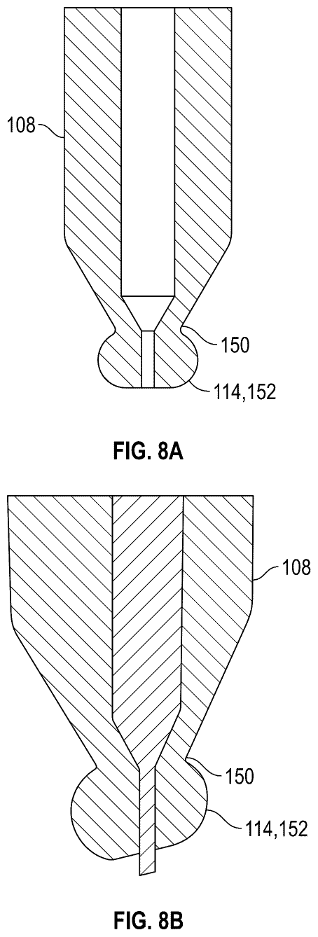

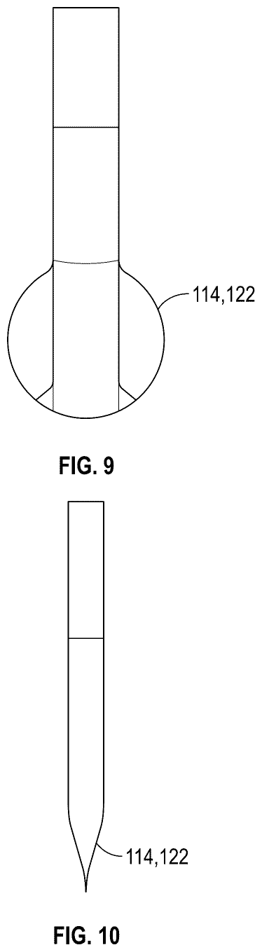

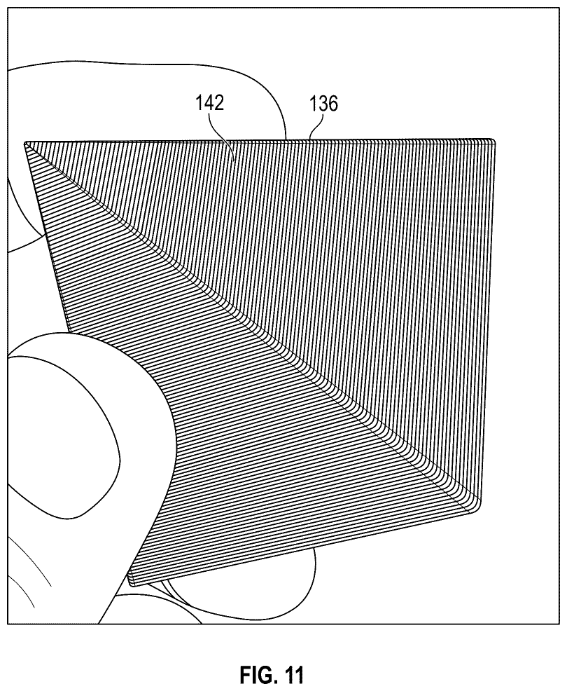

While the smoothing technique can be demonstrated with a conical tip 150 with pyramids and cones, minor improvements in surface finish could be achieved for typical variety of parts. To vary or alter the three-dimensionally printed part 136 geometries that are smooth-able, a reflow tool 114 may be provided exhibiting other geometries such as a truncated ball end profile of the tip 150 of the heated extrusion nozzle 108 as illustrated in FIGS. 8A and 8B and modulated in the z direction to control the approach angle of the smoothing surface. Additional geometries illustrated include a spherical ball end profile smoothing tool 122 in FIG. 9 and a curved cone smoothing tool 122 in FIG. 10. It should be appreciated that additional geometries may be assumed by the reflow tools 114. To enable treatment of geometries common in additive manufacturing, a set of reflow tools 114, including or not including the heated extrusion nozzle tip 150, with various profiles including ball end, and conical tip profiles may be employed and fit in the three-dimensional printer 102 to accommodate various flat, angled, convex angled external surfaces, and concave pockets. Thus, it should be appreciated that the smoothing profile of a given reflow tool 114, 150 is +/−10 degrees, including all values and ranges from 0 to +/−10 degrees of the surface 142, 144 to be treated.

With reference back to FIG. 2, at block 210 the three-dimensionally printed part 136 is printed and the filament 116 is reflowed and displaced by passing the reflow tool 114 over the surfaces 142 of the part oriented in the build direction as illustrated in FIG. 6. Surfaces oriented in the build direction are understood as those surfaces 142 that include ridges 160 created by the deposition of the filament layers 118 on top of each other. In aspects, multiple “passes” in the Z direction (or build direction) by the reflow tool 114 over the surface 142 can be programmed in the G-code and made with the reflow tool 114 to minimize the ridges 160 and stair stepping of the contoured surface 142 to thereby minimize the surface roughness of the finished contoured layer. In aspects, there may be a tradeoff between the contact area of the reflow tool 114 and its ability to effectively reflow material and its durability, versus the minimum radius edge, slot, or pocket that the tool can interact with to reflow and produce a relatively high-quality surface finish.

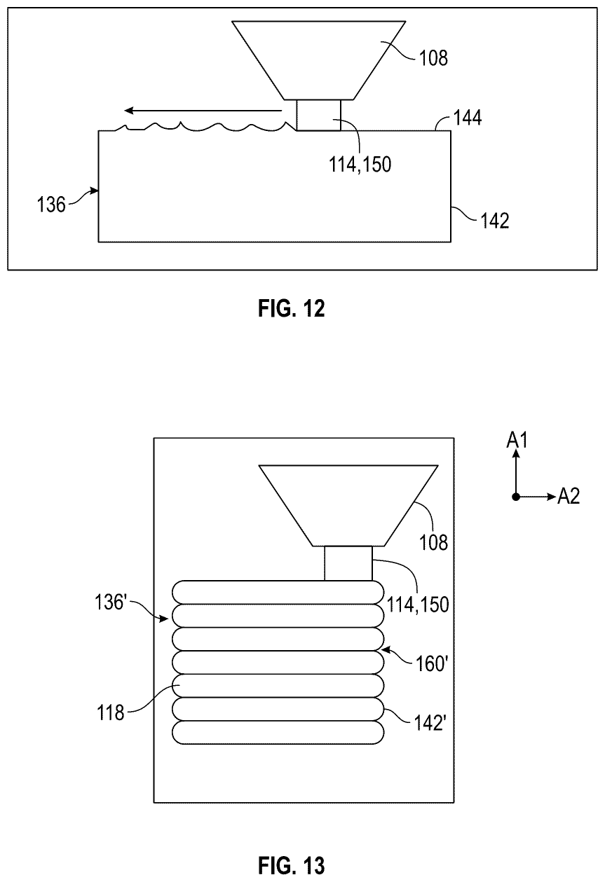

At block 214, after completing the three-dimensionally printed part 136, the upper surface 144, or last printed layer 1181, of the three-dimensionally printed part 136 is then smoothed using the reflow tool 114. Reference is made to FIG. 12, which illustrates the smoothing of a top surface 144 of a three-dimensionally printed part 136 with the bottom edge of a jewel heated extrusion nozzle tip 150. Smoothing of the top surface 144 of the three-dimensionally printed part 136 includes retracing the final print layer 1181 to smooth the surface 144 of the layer. It may be appreciated that, in aspects, the reflow tool 114 is dropped in the build direction a stepdown 316 sufficient to create an interference in the range of 10 to 100 microns, including all values and ranges therein, with the surface of the layer and, optionally, also the reflow tool 114 also performs a stepover 300 in the x, y plane A2-A3. The result is a three-dimensionally printed part 136 that includes relatively smooth surfaces 142, 144 as compared to a three-dimensionally printed part 136′ with untreated surfaces 142′ oriented in the build direction, such as illustrated in FIG. 13, which includes a number of ridges 160′ formed by the filament layers 118′.

In aspects, the temperature of the reflow tool 114 is set at a temperature greater than the heat deflection temperature of the filament, and in aspects, the reflow tool 114 is set at a temperature greater than the heat deflection temperature of the filament to a temperature of which the filament material is flowable and the polymer chains at the filament surface may slip past one another. In yet additional aspects, the temperature of the reflow tool 114 is set at a temperature that is less than the filament material degradation temperature, including all values and ranges between greater than the heat deflection temperature and less than the degradation temperature. In aspects in which the reflow tool 114 is the heated extrusion nozzle tip 150, the temperature of the heated extrusion nozzle tip 150 is controlled through control of the heated extrusion nozzle 108 temperature. In alternative or additional aspects, the reflow tool 114 is heated by a resistance heater provided around the nozzle. In additional or alternative aspects, other energy inputs such as rotary friction heating, ultrasonic, or infrared heat may be employed. In aspects, filament material is not removed or cut away from the part but rather reformed to generate a smooth surface 142, 144 contour. In further aspects, the reflowing of the filament material seals the treated surfaces 142, 144, which reduces surface porosity.

A first article demonstration of this technique has been performed using a three-dimensional printer 102 with a standard, off-the-shelf, conical tapered extrusion heated extrusion nozzle tip 150. To accommodate the taper, a three-dimensionally printed part 136 in the form of a pyramid, illustrated in FIG. 10, with a slope of the surface oriented in the build direction matching the conical heated extrusion nozzle tip 150 was printed and smoothed with the heated extrusion nozzle tip 150 using an aspect of the method, three-dimensional printer, and system described above. With reference to FIG. 3 and FIG. 4, G-code was prepared with a Prusa slicer for providing a first printing path 134 for printing the primary three-dimensionally printed part 136, then the model was scaled up, in this example, by 1 mm in overall size, and the extrusion multiplier was dropped to zero with a single outline to force the slicer to output travel moves around the primary pyramid to provide a secondary, smoothing path 140. The G-code was then interwoven after each z-layer 118 of the primary printing path 134, starting after the third layer of the primary printing path 134 so that the nozzle drops down and slightly away from the three-dimensional printed part 134 during its travel move as illustrated in FIG. 5. FIG. 5 illustrates a drop of 1.5 layers of printed filament from the upper surface 144 of the last filament layer 1181 printed and away from the three-dimensionally printed part 136 such that an interference between the three-dimensionally printed part 136 and the heated extrusion nozzle tip 150 e.g., 10 to 100 microns, including all values and ranges therein. In this manner the contact surface 115 of the heated extrusion nozzle tip 150 contacts the three-dimensionally printed part 136, but only intersects with the part by a margin of 10-100 microns. As noted above, the contact due to the interference is enough to smooth the round edges of the previous two deposited outer trace beads to make a smooth and sealed outer contour.

The three-dimensional printer, system, and method for smoothing and contouring three-dimensional object surfaces offer several advantages. These advantages include, for example, the containment of the system and method almost entirely in, if not completely within, the primary three-dimensional printing process. These advantages also include minimal or no additional hardware costs. These advantages further include the maintenance or improvement of the accuracy of geometric details in printed parts and retains most, if not all, of the primary chemical and physical properties of the build material. These advantages yet further include the removal of hardware limitations to enable a full-featured vertical surface contouring software workflow. These advantages further include an advancement in the utility and quality of material extrusion three-dimensional printed objects.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for contouring a three-dimensional printed part, comprising:
a three-dimensional printer including a three-dimensional print head carried by an x,y gantry in the three-dimensional printer, the three-dimensional print head including a heated extrusion nozzle; and
a processor control system, wherein the processor control system includes executable code to:
print a three-dimensionally printed part by depositing a filament trace in a printing path with the three-dimensional print head, wherein the three-dimensionally printed part includes a surface oriented in a build direction; and
smooth the surface oriented in the build direction by moving a reflow tool along a smoothing path while printing the three-dimensionally printed part.

2. The system of claim 1, wherein the process control system includes executable code to:
generate the primary print path from a representation of the three-dimensionally printed part, wherein the primary print path includes a plurality of primary print layers; and
generate a smoothing path, wherein the smoothing path includes a plurality of smoothing layers.

3. The system of claim 2, wherein the representation of the three-dimensionally printed part is scaled to create the smoothing path.

4. The system of claim 2, wherein the processor control system includes executable code to interweave the plurality of primary print layers and the plurality of smoothing layers.

5. The system of claim 4, wherein the processor control system includes executable code to begin the smoothing path after at least two of the plurality of primary print layers have been printed.

6. The system of claim 2, wherein the processor control system includes executable code to:
generate the primary printing path by creating commands for use by the three-dimensional printer through dividing the representation of the three-dimensionally printed part into the plurality of primary print layers and creating a plurality of instructions for depositing an extruded filament in each layer of the plurality of primary print layers.

7. The system of claim 2, wherein the processor control system includes executable code to:
generate the smoothing path by dividing the representation of the three-dimensionally printed part into the plurality of smoothing layers and creating the smoothing path at an offset from the printing path and creating a plurality of instructions for moving a reflow tool through the plurality of smoothing layers.

8. The system of claim 1, wherein the heated extrusion nozzle includes a heated extrusion nozzle tip and the reflow tool is the heated extrusion nozzle tip.

9. The system of claim 1, wherein instructions to smooth the surface include creating a texture or design in the surface.

10. The system of claim 1, wherein the reflow tool includes a contacting surface geometry and the reflow tool imparts a smoothing profile on the three-dimensionally printed part in a range of 0 to plus or minus 10 degrees inverse of the reflow tool contacting surface geometry.

11. A method for contouring a three-dimensional printed part, comprising:
printing a three-dimensionally printed part by depositing a filament in a primary print path with a three-dimensional print head, wherein the three-dimensionally printed part includes a surface oriented in a build direction; and
smoothing the surface oriented in the build direction by moving a reflow tool along a smoothing path while printing the three-dimensionally printed part.

12. The method of claim 11, further comprising:
generating the primary print path from a representation of a three-dimensionally printed part, wherein the primary print path includes a plurality of primary print layers;
generating a smoothing path, wherein the smoothing path includes a plurality of smoothing layers.

13. The method of claim 12, further comprising interweaving the plurality of primary print layers with the plurality of smoothing layers.

14. The method of claim 13, beginning the smoothing path after at least two of the plurality of primary print layers.

15. The method of claim 12, generating the primary print path by dividing the representation of the three-dimensionally printed part into the plurality of primary print layers and creating a plurality of instructions for depositing filament in each of the plurality of primary print layers.

16. The method of claim 12, generating the smoothing path by dividing the representation of the three-dimensionally printed part into the plurality of smoothing layers and creating the smoothing path at an offset from the printing path and creating a plurality of instructions for moving a reflow tool through the plurality of smoothing layers.

17. The method of claim 16, further comprising setting an extrusion multiplier to zero in the smoothing path when a headed nozzle tip is used as the reflow tool.

18. The method of claim 12, wherein the smoothing path creates interference between the reflow tool and the three-dimensionally printed part.

19. The method of claim 11, wherein smoothing includes imparting a texture or design in the surface.

20. A three-dimensional printer, comprising:
a processor control system, wherein the processor control system includes executable code to:
print a three-dimensionally printed part by depositing a filament trace in a printing path with the three-dimensional print head, wherein the three-dimensionally printed part includes a surface oriented in a build direction; and
smooth the surface oriented in the build direction by moving a reflow tool along a smoothing path while printing the three-dimensionally printed part.
